(19) United States
(12) Patent Application Publication
(10) Pub. No.: US 2003/0184053 A1
(43) Pub. Date: Oct. 2, 2003

(54) Hand-propelled golf bag cart

(76) Inventor: Richard H. Jacobs, Minneapolis, MN (US)

Correspondence Address: BRIGGS AND MORGAN, P.A., 2400 IDS CENTER, MINNEAPOLIS, MN, 55402, US

(21) Appl. No.: 10/112,492

(22) Filed: Mar. 28, 2002

(51) Int. Cl. B62B 1/00

(52) U.S. Cl. 280/645

(57) ABSTRACT

The invention comprises a hand driven golf cart for a golf bag having a collapsible frame for carrying the golf bag. An adjustable upper handle and two rear wheels are attached to the frame. A spherical front wheel is attached to a lower portion of the frame.

### FIELD OF THE INVENTION

The invention relates to a cart to hold and move a golf bag and accessories during a game of golf, and more particularly, to a hand driven, ergonomic, collapsible golf cart adapted to move easily over rough terrain.

### BACKGROUND

Playing the game of golf ordinarily involves using a series of golf clubs having differing head angles, sizes, weights and shaft characteristics to strike and move a golf ball various distances on varying terrain. A golf bag is used to improve the efficiency of carrying golf clubs and other required equipment while moving around a golf course. Many golfers, not wishing to manually carry the weight of a full golf bag employ a golf cart which is wheeled and able to be pulled or pushed by the golfer during a golf game. Such carts typically consist of either a two wheeled or three wheeled (“tricycle”) configuration whereby the weight of the golf bag, its contents, and the golf cart itself is distributed to the wheels of the golf cart.

A three wheeled golf cart has the advantage that it remains upright upon arrival at the tee or hole. A handle is attached allowing the golf cart to be pulled or pushed by the golfer thus moving the golf cart and its contents to the next location on the golf course. After arriving at a particular hole, a golfer may wish to reposition the golf cart so as to more effectively display the clubs. When using a traditional three wheeled golf cart, the front wheel has a relatively narrow tire which makes it difficult to pivot the golf cart into the most advantageous position.

In all cases, the front wheel receives a large proportion of the weight, making pivoting without deliberately lifting the front wheel difficult if not impossible. A further disadvantage of a traditional three wheeled golf cart is that the front wheel may damage the turf during attempted pivoting. What is clearly needed, then, is a three wheeled golf cart that both allows easy pivoting and will not damage the turf during pivoting.

### SUMMARY OF THE INVENTION

In one aspect, the invention comprises a hand driven golf cart for a golf bag having a collapsible frame for carrying the golf bag. An adjustable upper handle and two rear wheels are attached to the frame. A spherical front wheel is attached to a lower portion of the frame.

In another aspect, the invention comprises a collapsible golf cart having a frame. The frame has a beam defining an upper end and a lower end. An upper cradle is attached to the upper end of the beam and a lower cradle is attached to the lower end of the beam. The upper cradle has a handle attached to it. A first leg is attached to the beam and a second leg is also attached to the beam. The first leg has a first rear wheel attached to it and the second leg has a second rear wheel attached to it. A substantially spherical front wheel is attached to the frame.

In yet another aspect, the invention comprises a collapsible golf cart having a frame. The frame has a beam having an upper end and a lower end with an upper cradle fixedly attached to the upper end of the beam and a lower cradle fixedly attached to the lower end of the beam. A first leg is hingedly attached to the beam and a second leg is also hingedly attached to the beam. Hingedly attached to and extending from the upper cradle is an upper extension, and a handle is attached to the upper extension. At least one pocket is attached to the upper extension. A first rear wheel is rotatably attached to the first leg and a second rear wheel is rotatably attached to the second leg. A substantially spherical front wheel is attached to the frame. Hingedly attached between the first leg and the upper extension is a first fold rod and a second fold rod is similarly hingedly attached between the second leg and the upper extension.

Additional features and advantages of the golf cart include a cooler compartment and a storage compartment allow transportation of perishable food and other items while playing golf. A self-leveling drink holder prevents spillage of liquids while moving the golf cart. Ball, tee and score card holders are also provided.

### BRIEF DESCRIPTION OF THE DRAWINGS

FIG. 1 shows a perspective view of the golf cart from the right side;

FIG. 2 shows a left side elevational view of the golf cart in the fully extended configuration and which is a mirror image of the right side;

FIG. 3 shows the side view of FIG. 2 in a partly folded configuration;

FIG. 4 shows the side view of FIG. 2 the golf cart in a fully folded configuration;

FIG. 5 shows an elevational front view of the golf cart;

FIG. 6 shows a perspective view of the front wheel removed from the golf cart;

FIG. 7 shows a cross sectional view of the front wheel taken along lines 7-7 of FIG. 6;

FIG. 8 shows an alternative embodiment of the front wheel; and

FIG. 9 shows a perspective view of the insulated embodiment of a pocket.

### DETAILED DESCRIPTION

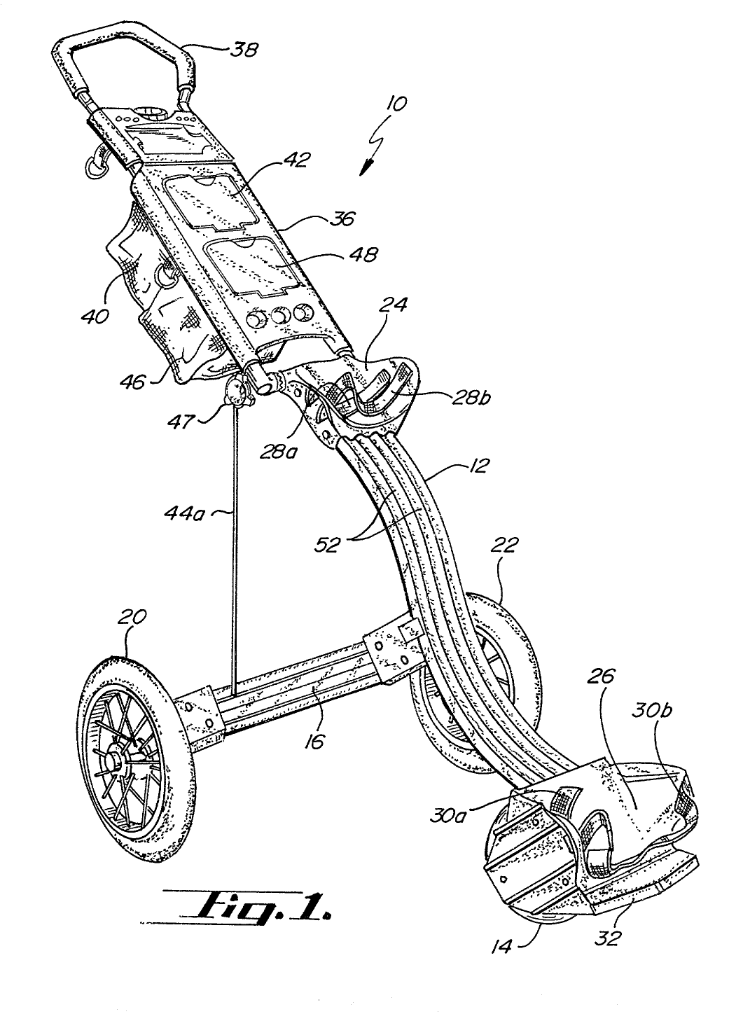

As best seen in FIG. 1, the golf cart 10 comprises a beam 12 extending in a longitudinal direction and defining an upper end 12a and a lower end 12b. In a preferred embodiment, the beam 12 is curved in at least one position along its length, however, the invention also contemplates a straight beam (not shown). A first leg 16 and a second leg 18 are hingedly attached to the beam 12 at positions opposite each other and extend away from the beam 12 and downward. In a preferred embodiment, the first and second legs 16, 18 extend from the beam 12 so as to form a mirror image, however, asymmetrical leg 16, 18 configurations (not shown) are also contemplated. A first rear wheel 20 is rotatably attached to the unattached lower end of the first leg 16 and in a similar manner a second rear wheel 22 is rotatably attached to the unattached lower end of the second leg 18. As discussed in greater detail below, a front wheel 14 is rotatably attached to a lower cradle 26 creating a three wheeled golf cart 10 able to bear the weight of a loaded golf bag 200 while providing easy repositioning of the golf cart 10.

An upper cradle 24 is attached to the upper end 12a of the beam 12 which serves to provide tabs, flanges or surfaces extending outward and also in a generally upward direction from the beam 12 to receive and secure the upper portion of a golf bag 200 when mounted to the golf cart 10 by upper straps 28a, 28b. A lower cradle 26 is attached to the lower end 12b of the beam 12 thus similarly serving to receive and secure the lower portion of a golf bag 200 when mounted to the golf cart 10 by lower straps 30a, 30b. The lower cradle 26 also has tabs, flanges or surfaces extending outward and upward from the beam 12 as well as a foot 32 extending in a direction upward from the first 20 and second 22 rear wheels at an approximately ninety degree angle to the beam 12 to help prevent the golf bag 200 from sliding off the golf cart 10 in a downward direction. The upper straps 28a, 28b and the lower straps 30a, 30b are provided with traditional fastening means such as hook and loop fastening material (not shown) or adjustable buckles (not shown).

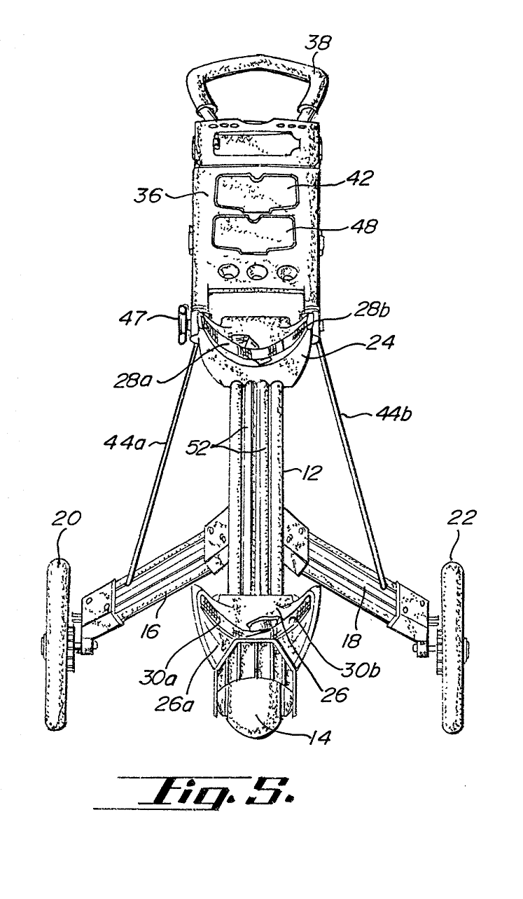

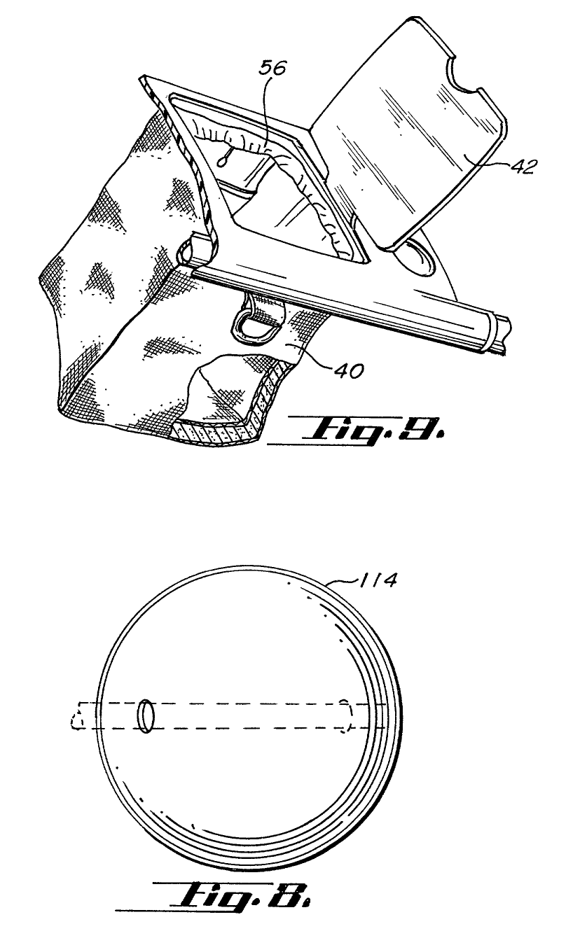

Attached to the lower cradle 26 is a front wheel 14, which in a preferred embodiment is non-pivotably attached and rotates about an axle as shown in FIGS. 7 and 8 when the golf cart 10 is pushed or pulled in a substantially co-linear direction with the beam 12. Also contemplated by and therefore within the scope of the invention is a (not shown) pivotably attached front wheel 14. In a preferred embodiment, as best shown in FIGS. 6 and 7, the front wheel 14 has a relatively wide and smooth surface area that more evenly distributes the weight supported by the front wheel 14.

The effect of a relatively wide and smooth surfaced front wheel 14 is that it will easily slide over and not damage the turf by digging in when the golf cart 10 is laterally moved without lifting the spherical front wheel 14. In the preferred embodiment, as shown in FIGS. 6 and 7, the front wheel 14 has a trifurcated construction, defining a center section 14a flanked by a first side section 14b and a second side section 14c. As best shown in FIG. 7, the center section 14a may be, but need not, be made of a softer material than the first and second side sections 14b, 14c.

In another embodiment as shown in FIG. 8, the front wheel 114 comprises a continuously smooth, round surface. In both embodiments of the front wheel 14, 114, an axle hole 34, 134 extends through the front wheel 14, 114 in a centered manner so as to allow rotation of the front wheel 14, 114 in a substantially longitudinal direction when mounted to the golf cart 10 via a traditional axle arrangement. In a preferred embodiment, the front wheel 14, 114 is mounted to flange or extension 26a and extension 26b of the lower cradle 26.

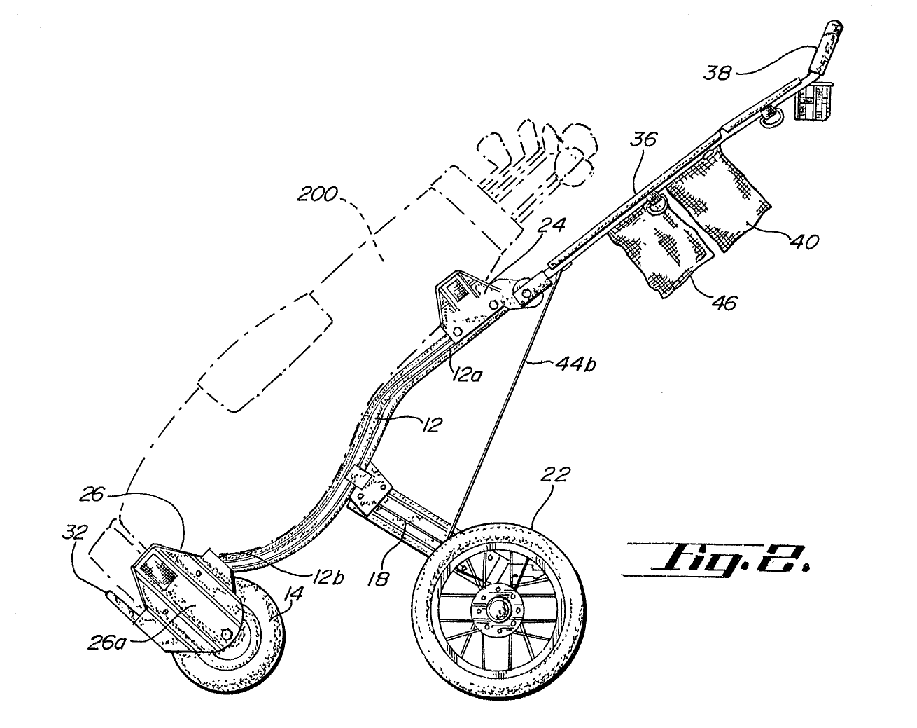

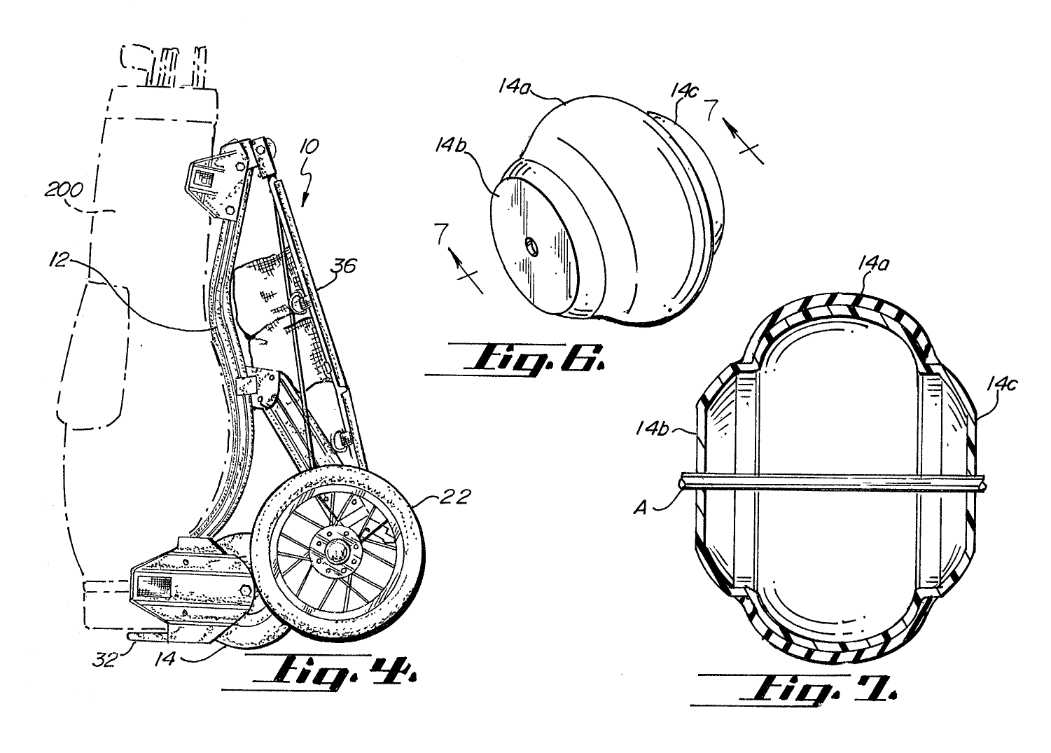

As best shown in FIG. 5, an upper extension 36 extends upward from and is rotatably hingedly attached to the upper cradle 24 toward the user and terminates in a conventional handle 38. The handle 38 as shown in FIGS. 1, 2, 3 and 5 is a continuous piece of aluminum tubing shaped so as to fit into openings (not shown) in the upper extension 36. An ergonomic, soft covering such as plastic foam may but need not cover the handle 38. The hinged attachment allows the upper extension 36 and handle 38 to rotate downward toward the beam 12.

A locking ratchet mechanism 47 prevents the upper extension 36 from rotating when locked. In a preferred embodiment, the locking mechanism 47 comprises interlocking surfaces molded into the upper extension 36 having starred indentations that lock when a bolt therethrough is tightened with a hand screw. Other locking mechanisms such as a simple friction fit would also work and are therefore contemplated by and within the scope of the invention.

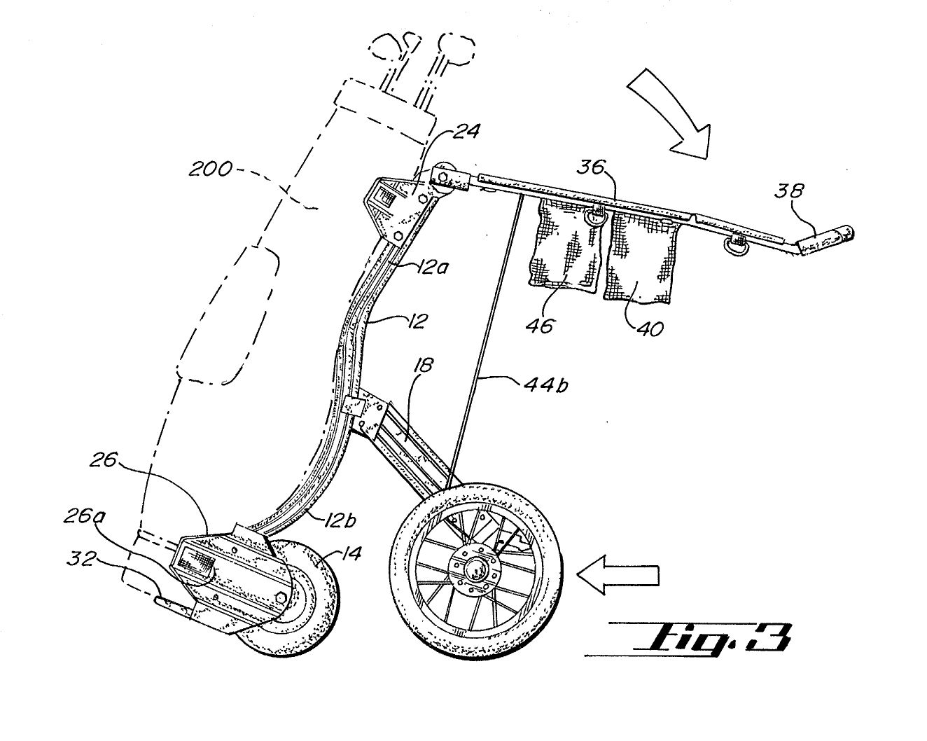

A first fold rod 44a is hingedly attached between the upper cradle 24 and the first leg 16 and in a similar manner, a second fold rod 44b is hingedly attached between the upper cradle 24 and the second leg 18. When the upper cradle 36 is locked in the fully extended position, as shown in FIGS. 1, 2 and 5, as it would be when using the golf cart 10, the first and second fold rods 44a, 44b help to stabilize the golf cart 10. Because the first and second fold rods 44a, 44b are hingedly attached to the first and second legs 16, 18 and the upper cradle 24, when the upper extension 36 is unlocked and rotated downward, as shown in FIG. 3, the first and second legs 16, 18 are moved toward the center of the beam 12, thus greatly reducing the space taken up by the golf cart 10. Maximum downward rotation of the upper extension 36 as shown in FIG. 4 causes the golf cart 10 to fold to its minimum size, thus allowing easier placement in the trunk of a car when transporting the golf cart 10 before or after a golf game. A further advantage of the golf cart 10 is that when folded to the fully folded configuration, it is still able to carry a golf bag 200 and function as a golf cart while occupying a minimum amount of space by standing on foot 32.

First and second pockets 40, 46 may be attached to the upper extension 36. The first pocket 40 has a first door 42 attached to it and in a similar manner the second pocket 46 has a second door 48 hingedly attached to it. The first and second pockets 40, 46 are designed to hold various golf equipment such as golf tees, etc. (not shown). In a preferred embodiment, the first 40 and second 46 pockets may also be constructed of an insulative material 50 allowing a cooled food or beverage item to be kept cool while in an outdoor environment and enjoyed while playing golf. In a preferred embodiment, the first 40 and second 46 pockets are flexible in nature, as discussed in greater detail below. Of course, the invention is not limited to first and second pockets 40, 46 but may comprise a single pocket (not shown) or more than two pockets (not shown).

Additional features that could be attached to the golf cart 10 include a self-leveling drink holder, a snap hook for keys, tee and ball holders, a score card holder with pencil clip, d-ring holders for towels and accessories, as well as rear parking brakes.

In a preferred embodiment, the beam 12 is made of extruded aluminum, but also may be made of a suitable plastic. The beam 12 may incorporate a plurality of ridges 52 along its length to increase longitudinal strength, however, this is not essential. The upper cradle 24 and lower cradle 26 are made from injection molded ABS plastic or the like due to its great strength and light weight. The handle 38 can be an injection molded integral portion of the upper cradle 24 or can incorporate aluminum or other metal or plastic members with various additional plastic members as desired.

The upper cradle 24 and any aluminum or metal members attached to the handle are fixedly attached to the beam and each other by means of riveting or other traditional fastening methods such as gluing or injection molding around the various separate metal or plastic members. The lower cradle 26 is preferably a unitary structure attached to the beam 12 by riveting or other traditional fastening methods. The doors 42, 48 of the first and second pockets 40, 46 are preferably made of plastic due to its insulative properties combined with high strength and light weight. The first and second pockets 40, 46 are preferably made of nylon cloth, which is flexible yet extremely strong and durable. When an insulative pocket 40 as shown in FIG. 9 is desired, a material such as foam can be laminated to or inserted within a pocket 40, 46 made of nylon cloth. The first and second legs 16, 18 are made of aluminum as are the first and second fold rods 44a, 44b. The first and second wheels 20, 22 are of conventional design and materials and may be either pneumatic or solid. The front wheel 14, 114 is preferably made of plastic however, a pneumatic wheel is also contemplated and therefore within the scope of the invention.

Using the golf cart 10 involves first unfolding the golf cart 10 from its storage configuration as shown in FIG. 4 to its fully extended configuration as shown in FIGS. 1, 2 and 5. This involves unlocking the upper extension 36 and rotating it upward so as to be approximately linear with the beam 12. The design of the golf cart 10 allows the position of the upper extension 36 to be varied somewhat and locked into various positions according to user preference. As discussed above in greater detail, the act of rotating the upper extension 36 upward simultaneously causes the first and second legs 16, 18 to move outward, thus giving the golf cart 10 a more stable wheelbase during use.

When the golf cart 10 is unfolded and locked in the desired configuration, it is necessary to determine that the upper straps 28a, 28b and lower straps 30a, 30b are unfastened and hanging to the side so as not to interfere with the placement of a golf bag 200 on the golf cart 10. Next, a presumably filled golf bag 200 is laid along the length of the beam 12 and rested against the foot 32. In either order, the upper straps 28a, 28b and lower straps 30a, 30b are placed around the golf bag 200, fastened together, and tightened to secure the golf bag 200 to the golf cart 10. Any desired items are inserted into the pockets 40, 46 and the golfer is ready to play golf. Following a golf game, the above described procedure is reversed.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention.

What is claimed:

1. A hand driven golf cart for a golf bag, comprising:
(a) collapsible frame for carrying the golf bag, with an adjustable upper handle and two rear wheels and;
(b) a front spherical wheel connected to a lower portion of the frame.

2. The golf cart of claim 1 wherein the front wheel further comprises a weight bearing central portion interposed between two side portions.

3. The golf cart of claim 1 wherein the front wheel is non-pivotably attached to the frame.

4. A collapsible golf cart, comprising:
(a) a frame comprising:
(i) a beam having an upper end and a lower end;
(ii) an upper cradle attached to the upper end of the beam;
(iii) a lower cradle attached to the lower end of the beam;
(iv) a first leg attached to the beam; and
(v) a second leg attached to the beam;
(b) a handle attached to the upper cradle;
(c) a first rear wheel attached to the first leg and a second rear wheel attached to the second leg; and
(d) a substantially spherical front wheel attached to the lower cradle.

5. The golf cart of claim 4 wherein the front wheel further comprises a weight bearing central portion interposed between concentric side portions.

6. The golf cart of claim 4 wherein the front wheel is non-pivotably mounted to the lower cradle.

7. The golf cart of claim 4 wherein at least one pocket for containing items is attached to the golf cart.

8. The golf cart of claim 7 wherein the pocket has a closable door.

9. The golf cart of claim 8 wherein the at least one pocket is made of an insulative material.

10. A collapsible golf cart, comprising:
(a) frame capable of an extended configuration and a folded configuration, comprising:
(i) a beam having an upper end and a lower end;
(ii) an upper cradle fixedly attached to the upper end of the beam;
(iii) a lower cradle fixedly attached to the lower end of the beam;
(iv) a first leg hingedly attached to the beam; and
(v) a second leg hingedly attached to the beam;
(vi) an upper extension hingedly attached to and extending from the upper cradle;
(vii) a handle attached to the upper extension;
(b) a first rear wheel rotatably attached to the first leg and a second rear wheel rotatably attached to the second leg;
(c) a substantially spherical front wheel attached to the lower cradle;
(d) at least one pocket attached to the upper extension;
(e) a first fold rod hingedly attached between the first leg and the upper extension; and
(f) a second fold rod hingedly attached between the second leg and the extension.

11. The golf cart of claim 10 wherein the front wheel further comprises a weight bearing central portion interposed between concentric side portions.

12. The golf cart of claim 10 wherein the front wheel is non-pivotably mounted to the lower cradle.

13. The golf cart of claim 10 wherein the pocket has a closable door and is made of an insulative material.
